(19) United States
(12) Patent Application Publication
(10) Pub. No.: US 2008/0012918 A1
(43) Pub. Date: Jan. 17, 2008

(54) Actinic Radiation Curable Ink-Jet Ink, And Image Forming Method And Ink-Jet Recording Apparatus Using The Same

(76) Inventors: Satoshi Masumi, Tokyo (JP); Daisuke Ishibashi, Tokyo (JP)

Correspondence Address: CANTOR COLBURN, LLP, 55 GRIFFIN ROAD SOUTH, BLOOMFIELD, CT, 06002, US

(21) Appl. No.: 11/666,932

(22) PCT Filed: Nov. 7, 2005
(86) PCT No.: PCT/JP05/20369

§ 371 Date: May 3, 2007

(30) Foreign Application Priority Data
Nov. 9, 2004 (JP) 2004-324736

(51) Int. Cl. B41J 2/01; C09D 11/10

(52) U.S. Cl. 347/102; 106/31.78

(57) ABSTRACT

An actinic radiation curable ink-jet ink exhibiting excellent storage stability and curability, characterized by incorporating a benzimidazolone based pigment, a dispersing agent, a cationically polymerizable monomer which is an oxetane compound, a photolytically acid generating agent, and a benzimidazolone derivative.

### TECHNICAL FIELD

The present invention relates to an actinic radiation curable ink-jet ink capable of stably reproducing high definition images, and an image forming method and an ink-jet recording apparatus using the same.

### BACKGROUND OF THE INVENTION

In recent years, since ink-jet recording methods are capable of easily forming images at low cost, they have been adapted to various printing fields such as photographic printing, various types of printing, or special printing such as marking or color filters. By employing ink-jet recording apparatuses which eject minute dots of ink and control them, ink-jet inks which have been subjected to improvement of color reproduction, durability, and ejection adaptability, and specified paper media which have been subjected to significant enhancement of color forming properties of colorants and surface glossiness, it has become possible to achieve image quality comparable to silver halide photography. Image quality of the present ink-jet recoding systems is enhanced only when an ink-jet recording apparatus, an ink-jet ink and a specified paper medium are simultaneously improved.

However, ink-jet systems which require specified kinds of paper result in problems such that recording media are limited and using such recording media increases cost. Accordingly, many trials have been made in which recording, employing the ink-jet systems, is carried out on transfer media which are different from specified kinds of paper. Specific systems include a phase-changing ink-jet system employing a wax ink which is solid at room temperature, a solvent based ink-jet system employing rapidly drying organic solvents as a main component, and an actinic radiation curable type ink-jet system in which, after recording, actinic radiation such as ultraviolet radiation (UV radiation) is exposed to result in crosslinking.

Of these, the UV ink-jet system results in low unpleasant odor, compared to a solvent based ink-jet system. Such UV radiation curable type ink-jet inks are disclosed (refer, for example, to Patent Documents 1 and 2).

However, even though the above actinic radiation curable ink-jet inks are employed, the diameter of dots after deposition of ink droplets is subjected to a large change, whereby it is impossible to form highly detailed viable images on various recording materials.

In recent years, proposed have been many UV radiation curable type ink-jet inks employing cationically polymerizable compounds. These UV radiation curable type ink-jet inks are not subjected to inhibition due to oxygen, but a problem occurs in which the above inks tend to be adversely affected by molecular level moisture (humidity). Further, depending on the curing ambience, another problem occurs in which wrinkling is formed due to curing contraction.

Features of image formation via the UV radiation curable type ink-jet system are that high quality images are prepared at low cost and image formation can be realized on recording materials which absorb no ink. However, the above UV radiation curable type ink-jet system results in specific problems. For example, when images are formed on the recording material which absorb no ink, deposited dots mix with adjacent dots to result in significant degradation of image quality. Particularly, when high definition images are required, mixing of deposited color dots results in a critical problem. In order to overcome the above drawbacks, disclosed are actinic radiation curable ink-jet inks, employing oxirane compounds, vinyl ether compounds, or oxetane compounds as a photopolymerizable compound (refer, for example, to Patent Documents 3 and 4). Further disclosed are actinic radiation curable ink-jet inks employing alicyclic epoxy compounds and oxetane compounds as a photopolymerizable compound (refer, for example, to Patent Documents 5 and 6). Presently, however, the above proposed methods do not sufficiently minimize dot bleeding.

In the case of common aqueous ink-jet systems, the above drawbacks have been overcome via enhancement of ink penetration into recording materials by incorporating additives exhibiting each function into specified paper and ink. In the present UV radiation curing type ink-jet system, no method has been found to overcome the above drawbacks of an image forming method in which recording materials, which do not absorb ink, are employed. Further, in the case of high rate printing, formed images are often wound, whereby it has been demanded to develop actinic radiation curable ink-jet ink compositions which exhibit quick curing characteristics of the formed images.

Patent Document 1: Japanese Patent Publication Open to Public Inspection (hereinafter referred to as JP-A) No. 6-200204 (claims and examples)

Patent Document 2: Japanese Patent Publication Open to Public Inspection (under PCT Application) No. 2000-504778 (claims and examples)

Patent Document 3: JP-A) No. 2001-220526 (claims and examples)

Patent Document 4: JP-A No. 2002-188025 (claims and examples)

Patent Document 5: JP-A No. 2002-317139 (claims and examples)

Patent Document 6: JP-A No. 2003-55449 (claims and examples)

### SUMMARY OF THE INVENTION

In view of the above problems, the present invention was achieved. It is an object of the present invention to provide an actinic radiation curable ink-jet ink which exhibits excellent storage stability and curability, and an image forming method and an ink-jet recording apparatus using the same.

The above object of the present invention enables achievement via the following embodiments.

1. An actinic radiation curable ink-jet ink incorporating benzimidazolone based pigments, dispersing agents, cationically polymerizable monomers which are oxetane compounds, photolytically acid generating agents, and benzimidazolone derivatives.

2. The actinic radiation curable ink-jet ink, described in above 1., further comprising a cationically polymerizable monomer which is a compounds having an oxirane ring.

3. The actinic radiation curable ink-jet ink described in above 2., wherein the aforesaid compound having an oxirane ring is a compound represented by following Formula (1):

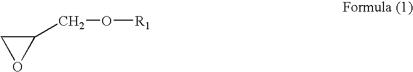

wherein R₁ is an unsubstituted or substituted alkyl group which has 1-10 carbon atoms, an unsubstituted or substituted aromatic group, or an unsubstituted or substituted acyl group.
4. The actinic radiation curable ink-jet ink described in 2., wherein the aforesaid compound having an oxirane ring, are represented by following Formula (2):

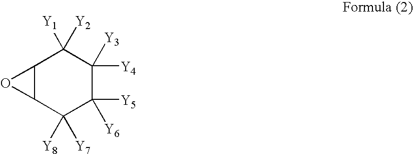

wherein Y₁-Y₈ are each a hydrogen atom, an unsubstituted or substituted alkyl, carbonyl, alkoxy, or cycloalkoxy group, each of Y₁-Y₈ may be different, and Y₁ and Y₈ may combine with each other to form a methylene bond or an ether bond.

5. The actinic radiation curable ink-jet ink described in 2.,

wherein the aforesaid compound having an oxirane ring is an α-pinene oxide.

6. The actinic radiation curable ink-jet ink described in 2.,

wherein the above compound having an oxirane ring is 1, 2:8,9-diepoxylimonene.

7. The actinic radiation curable ink-jet ink described in 2.,

wherein the aforesaid compound having an oxirane ring is an epoxidized vegetable oil having an unsaturated bond.
8. The actinic radiation curable ink-jet ink, described in 2., wherein the aforesaid compound having an oxirane ring is represented by following Formula (A):

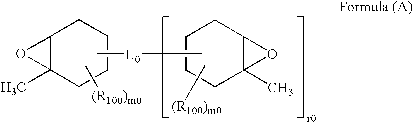

wherein R₁₀₀ is a substituent, m0 is an integer of 0-2, r0 is an integer of 1-3, and L₀ is (r0+1) valent bonding group having 1-15 carbon atoms, a main chain of which may contain an oxygen atom or a sulfur atom, or L₀ is a single bond.

9. The actinic radiation curable ink-jet ink described in any one of 1.-8.,

wherein the aforesaid benzimidazolone derivative is represented by following Formula (B1):
P_{b1}—(SO₃H)ₙ₃ Formula (B1)

wherein P_{b1} is a benzimidazolone pigment moiety and n3 is an integer of 1 or 2.

10. An image forming method comprising the steps of:

(1) ejecting the actinic radiation curable ink-jet ink described in any one of 1.-9. above from an ink-jet recording head onto a recording material, and

(2) irradiating actinic radiation onto the ejected ink to cure an image on the recording material.

11. The image forming method comprising the steps of:

(1) ejecting the actinic radiation curable ink-jet ink described in any one of 1.-9. from an ink-jet recording head onto the recording material, and

(2) irradiating actinic radiation onto the ejected ink to cure an image on the recording material,

wherein actinic radiation is conducted during 0.001-1 second after deposition of the ink onto the recording material.

12. The image forming method comprising the steps of:

(1) ejecting the actinic radiation curable ink-jet ink described in any one of 1.-9. from an ink-jet recording head onto the recording material, and

(2) irradiating actinic radiation onto the ejected ink to cure an image on the recording material,

wherein a total cured ink layer thickness is 2-25 μm.

13. The image forming method comprising the steps of:

(1) ejecting the actinic radiation curable ink-jet ink described in any one of 1.-9. from an ink-jet recording head onto the recording material, and

(2) irradiating actinic radiation onto the ejected ink to form an image on the recording material,

wherein a droplet volume of the actinic radiation curable ink-jet ink ejected from the nozzles is 2-20 pl.

14. The image forming method described in any one of 10.-13. above,

wherein the ink-jet recording head is a line head.

15. An ink-jet recording apparatus employed in the image recording method described in any one of 10.-14.,

wherein the ink-jet recording apparatus has a mechanism in which the actinic radiation curable ink is ejected after the ink and the ink-jet recording head are heated to 35-100° C.

### EMBODIMENTS

Based on the present invention, it is possible to provide an actinic radiation curable ink-jet ink which exhibits excellent storage stability and curability, and an image forming method and an ink-jet recording apparatus using the same.

### BRIEF DESCRIPTION OF THE DRAWINGS

FIG. 1 is a front view showing one example of a structure of the main section of the ink-jet recording apparatus of the present invention.

FIG. 2 is a front view showing another example of a structure of the main section of the ink-jet recording apparatus of the present invention.

### DESCRIPTION OF THE DESIGNATIONS

1 ink-jet recording apparatus
2 head carriage
3 ink-jet recording head
31 ink ejection orifice
4 exposure means
5 platen section
6 guiding member
7 bellows structure
P recording material

### DESCRIPTION OF THE PREFERRED EMBODIMENTS

Preferred embodiments to practice the present invention will now be detailed.

In view of the above problems, the inventors of the present invention conducted diligent investigation. As a result, it was discovered that an actinic radiation curable ink-jet ink capable of exhibiting excellent curability, resulting in no color mixing, and stably recording high definition images was realized via incorporation of at least a benzimidazolone based pigment, a dispersing agent, an oxetane compound as a cationically polymerizable monomer, and a photolytically acid generating agent, as well as a benzimidazolone derivative, whereby the present invention was realized.

Examples of benzimidazolone based pigments usable in the present invention include C.I. Pigment Yellow 120, C.I. Pigment Yellow 151, C.I. Pigment Yellow 154, C.I. Pigment Yellow 167, C.I. Pigment Yellow 175, C.I. Pigment Yellow 180, C.I. Pigment Yellow 181, and C.I. Pigment Yellow 194.

It is preferable that pigments are dispersed to result in an average diameter of pigment particles of 0.05-0.5 μm. Further, pigments and dispersion media are selected and dispersion conditions and filtration conditions are appropriately set so that the maximum diameter is regulated to 0.5-10 μm, but preferably 0.3-0.5 μm. Via the above particle diameter management, it is possible to minimize clogging of head nozzles, and to maintain ink storage stability, ink transparency and curing speed.

As a dispersing agent, it is preferable to employ polymer dispersing agents. The polymer dispersing agents include the SOLSPERS SERIES such as SOLSPERS 3200, SOLSPERS 2400GR, SOLSPERS 2800, SOLSPERS 13240, SOLSPERS 13940, SOLSPERS 33500, SOLSPERS 38500, and SOLSPERS 34570, all produced by Avecia Ltd.; the PB SERIES such as PB 821, PB 822, or PB 711, all produced by Ajinomoto Fine-Techno Co., Inc.; EFKA-4046, EFKA-4300, EFKA-4330, EFKA-7411, EFKA-7462, EFKA-7476, EFKA-7496, EFKA-5207, EFKA-5255, EFKA-6220, EFKA-6225, and EFKA-7544, all produced by Efka Additives Co.; DISPERBYK-161, DISPERBYK-162, DISPERBYK-163, DISPERBYK-164, DISPERBYK-166, DISPERBYK-171, DISPERBYK-116, DISPERBYK-2000, DISPERBYK-2001, DISPERBYK-2050, DISPERBYK-2150, DISPERBYK-182, DISPERBYK-184, and DISPERBYK-142, all produced by BYK-Chemie Japan k.k.; HINOACT T-6000 and HINOACT T-8000, produced by Kawaken Fine Chemicals Co., Ltd.; and DISPERON DA-703-50, DISPERON DA-725, DISPERON DA-705, DISPERON DA-325, and DISPERON DA-234, all produced by Kusumoto Chemicals, Ltd.

The added amount of these dispersing agents is preferably 10-100 parts by weight with respect to 100 parts by weight of the pigments, but is more preferably 10-60 parts by weight. The reason for that is assumed to be as follows. When cationically polymerizable monomers are cured, dispersing agents trap photolytically generated acids.

Solvents or polymerizable compounds are employed as a dispersion medium. In the actinic gradation curable type ink-jet ink employed in the present invention, in order to realize the targeted reaction and curing immediately after deposition ink droplets, it is preferable that no solvent is present. When solvents remain in cured images, problems such as degradation of solvent resistance occur. Consequently, in view of dispersion adaptability, it is preferable to select, as a dispersion medium, polymerizable monomers, especially those exhibiting the lowest viscosity, instead of solvents.

Oxetane compounds, as described herein, refer to compounds having an oxetane ring. Employed as compounds having an oxetane ring may be any of the appropriate oxetane compounds known in the art, which are disclosed in JP-A Nos. 2001-220526 and 2001-310937. Further, in order to enhance layer strength after curing and close adhesion onto recording materials, it is preferable to employ monofunctional oxetane compounds having one oxetane ring together with multifunctional oxetane compounds having at least two oxetane rings. In view of handling and adhesion, the oxetane compounds according to the present invention are those which preferably have 1-4 oxetane rings.

In the ink-jet ink of the present invention, it is preferable that the above compounds having oxetane ring(s) are employed together with compounds having oxirane ring(s). Compounds having oxirane ring(s) are not particularly limited. However, preferred compounds include those represented by above Formula (1), compounds represented by above Formula (2), α-pinene oxides, 1, 2:8,9-diepoxylimonene, expoxidized vegetable oil having an unsaturated bond, and the compounds represented by following Formula (A).

Compounds having each of the oxirane rings, which are usable in the ink-jet ink of the present invention, will now be described.

In above Formula (1), R₁ represents an unsubstituted or substituted alkyl group which has 1-10 carbon atoms (for example, a methyl group, an ethyl group, a propyl group, a butyl group, an isopropyl group, a t-butyl group, a hexyl group, a 2-ethylhexyl group, and a benzyl group); an unsubstituted or substituted aromatic group (for example, a phenyl group and a naphthyl group); or an substituted or substituted acyl group (for example a benzoyl group, a methacryl group, and a stearyl group). Of these, the alkyl group is preferred.

The specific examples represented by above Formula (1) will be listed below; however, the present invention is not limited thereto.

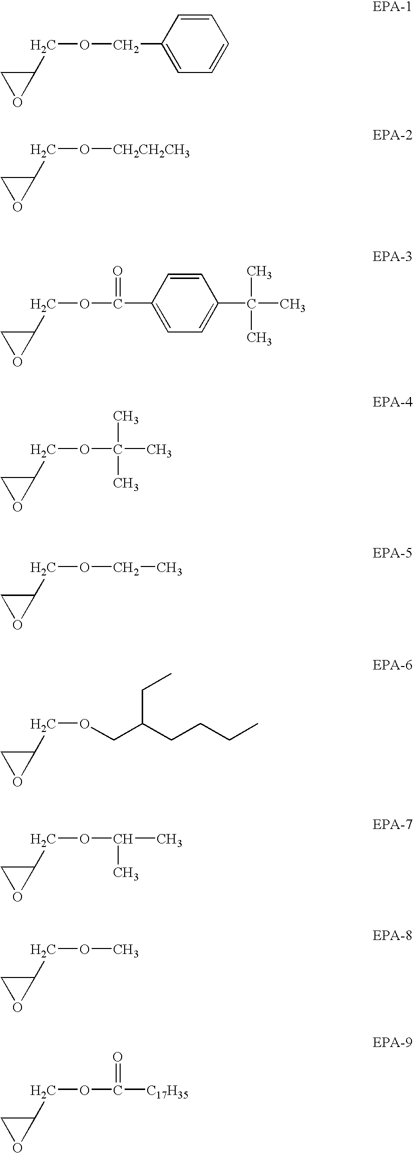

Further, the compounds having an oxirane ring represented by above Formula (2) will now be described.

In above Formula (2), Y₁-Y₈, which may differ, each represent a hydrogen atom, an unsubstituted or substituted alkyl group (for example, a methyl group, an ethyl group, a propyl group, a butyl group, an isopropyl group, a tert-butyl group, a hexyl group, a 2-ethylhexyl group, and a benzyl group), an unsubstituted or substituted carbonyl group (for example, an acetyl group and a benzoyl group), an alkoxy group, or a cyclroalkoxy group. Y₁ and Y₈ may join to form a methylene or ether bond.

Preferred examples of the compounds having an oxirane ring represented by above Formula (2) include the compounds represented by above Formulas (III) and (IV) shown below.

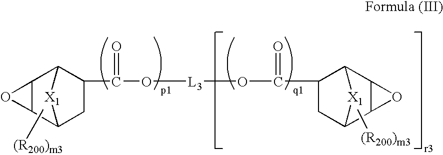

In above Formula (III), R₂₀₀ represents an aliphatic group located in any position except for in the α or β position of the oxirane ring, and m3 represents 0-2. X₁ represents —(CH₂)ₙ₀— or —(O)ₙ₀—, and n0 represents 0 or 1. p1 and q1 each represent 0 or 1, not being 0 simultaneously. r3 represents 1-3. L₃ represents a connecting group or a single bond. The connecting group has a branched structure with (r3+1) valence having 1 to 15 carbon atoms. The connecting group may have oxygen atoms or sulfur atoms in its main chain.

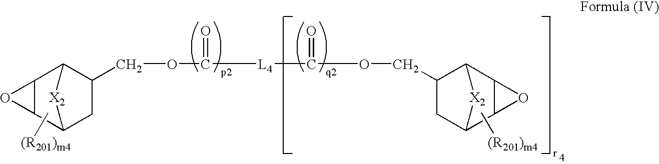

In above Formula (IV), R₂₀₁ represents an aliphatic group located in any position except for in the α or β position of the oxirane ring, and m4 represents 0-2. X₂ represents —(CH₂)ₙ₁— or —(O)ₙ₁—, and n1 represents 0 or 1. p2 and q2 each represent 0 or 1, not being 0 simultaneously. r4 represents 1-3. L₄ represents a connecting group or a single bond. The connecting group has a branched structure with (r4+1) valence having 1 to 15 carbon atoms. The connecting group may have oxygen atoms or sulfur atoms in its main chain.

The compounds having the oxirane rings represented by above Formulas (III) and (IV) are detailed below.

In above Formula (III), R₂₀₀ represents an aliphatic Group located in any position except for in the α or β position of the oxirane ring. Examples of the aliphatic group include an alkyl group having 1-6 carbon atoms (for example, a methyl group, an ethyl group, a propyl group, an isopropyl group, and a butyl group), a cycloalkyl group having 3-6 carbon atoms (for example, a cyclopropyl group, cyclobutyl group, a cyclopentyl group, and a cyclohexyl group), an alkenyl group having 1-6 carbon atoms (for example, a vinyl group, a 1-propenyl group, a 2-propenyl group, and a 2-butenyl group), and an alkynyl group having 1-6 carbon atoms (for example, an acetyrenyl group, a 1-propynyl group, a 2-propynyl group, and a 2-butynyl group). Preferred examples include an alkyl group having 1-3 carbon atoms, more preferably a methyl group and an ethyl group.

m3 represents 0-2, but is preferably 1 or 2. X₁ represents —(CH₂)ₙ₀— or —(O)ₙ₀—, and n0 represents 0 or 1. Provided n0 is 0, X₁ is not present. m3 plus n0 is preferably not less than 1. L₃ represents a connecting group or a single bond. The connecting group has a branched structure with (r3+1) valence having 1 to 15 carbon atoms. The connecting group may have oxygen atoms or sulfur atoms in its main chain. p1 and q1 each represent 0 or 1, not being 0 simultaneously. r3 represents 1-3.

Further, the compounds having oxirane rings, represented by above Formula (IV), will now be described.

In above Formula (IV), R₂₀₁ represents an aliphatic group located in any position except for in the α or β position of the oxirane ring. Examples of the aliphatic group include an alkyl group having 1-6 carbon atoms (for example, a methyl group, an ethyl group, a propyl group, an isopropyl group, and a butyl group), a cycloalkyl group having 3-6 carbon atoms (for example, a cyclopropyl group, cyclobutyl group, a cyclopentyl group, and a cyclohexyl group), an alkenyl group having 1-6 carbon atoms (for example, a vinyl group, a 1-propenyl group, a 2-propenyl group, and a 2-butenyl group), and an alkynyl group having 1-6 carbon atoms (for example, an acetyrenyl group, a 2-propynyl group, and a 2-butynyl group). Preferred examples include an alkyl group having 1-3 carbon atoms, more preferably a methyl group and an ethyl group.

m4 represents 0-2, but is preferably 1 or 2. X₂ represents —(CH₂)ₙ₁— or —(O)ₙ₁—, and n1 represents 0 or 1. Provided n1 is 0, X₂ is not present. m4 plus n1 is preferably not less than 1. P2 and q2 each represent 0 or 1, not being 0 simultaneously. r4 represents 1-3.

L₄ represents a connecting group or a single bond. The connecting group has a branched structure with (r4+1) valence having 1 to 15 carbon atoms. The connecting group may have oxygen atoms or sulfur atoms in its main chain.

In above Formula (III) or (IV), examples of the Divalent connecting groups having 1 to 15 carbon atoms, which may have oxygen atoms or sulfur atoms in their main chain, include the following groups. These groups may be combined with a plurality of groups of an —O— group, a —S— group, a —CO— group, and a —CS— group.
ethylidene group: >CHCH₃,
isopropylidene group: >C(CH₃)₂,
2,2-dimethyl-1,3-propanediyl group: —CH₂C(CH₃)₂CH₂—,
2,2-dimethoxy-1,3-propanediyl group: —CH₂C(OCH₃)₂CH₂—,
2,2-dimethoxymethyl-1,3-propanediyl group: —CH₂C(CH₂OCH₃)₂CH₂—,
1-methyl-1,3-propanediyl group: —CH(CH₃) CH₂CH₂—,
1,4-dimethyl-3-oxa-1,5-pentanediyl group: —CH(CH₃) CH₂OCH(CH₃) CH₂—,
1,4,7-trimethyl-3,6-dioxa-1,8-octanediyl group: —CH(CH₃) CH₂OCH(CH₃) CH₂OCH(CH₃) CH₂—
5,5-dimethyl-3,7-dioxa-1,9-nonanediyl group: —CH₂CH₂OCH₂C(CH₃)₂CH₂OCH₂CH₂—
5,5-dimethoxy-3,7-dioxa-1,9-nonanediyl group: —CH₂CH₂OCH₂C(OCH₃)—
5,5-dimethoxymethyl-3,7-dioxa-1,9-nonanediyl group: —CH₂CH₂OCH₂C(CH₂OCH₃)₂CH₂OCH₂CH₂—, and
isopropylidenebis-p-phenylene group: -p-C₆H₄—C(CH₃)₂-p—C₆H₄—

Examples of the connecting groups, being trivalent or more, include groups formed by eliminating the necessary number of the hydrogen atoms which are located in any of the positions of the above-exemplified divalent connecting

groups,

and groups formed by combining these aforesaid groups with a plurality of groups of an —O— group, a —S— group, a —CO— group, and a —CS— group.

L₃ and L₄ may have substituents. Examples of the substituents include a halogen atom (for example, a chlorine atom, a bromine atom, and a fluorine atom), an alkyl group having 1-6 carbon atoms (for example, a methyl group, an ethyl group, a propyl group, an isopropyl group, and a butyl group), an alkoxy group having 1-6 carbon atoms (for example, a methoxy group, an ethoxy group, a n-propoxy group, an isopropoxy group, a n-butoxy group, and a tert-butoxy group), an acyl group (for example, an acetyl group, a propionyl group, and a trisluoroacetyl group), an acyloxy group (for example, an acetoxy group, a propionyloxy group, and a trifluoroacetetoxy group), an alkoxycarbonyl group (for example, a methoxycarbonyl group, an ethoxycarbonyl group, and a tert-butoxycarbonyl group). Preferred examples of the substituents include a halogen atom, an alkyl group, and an alkoxy group.

Examples of the compounds having epoxy groups

presented
by above Formula (2) will now be listed; however, the present invention is not limited thereto.

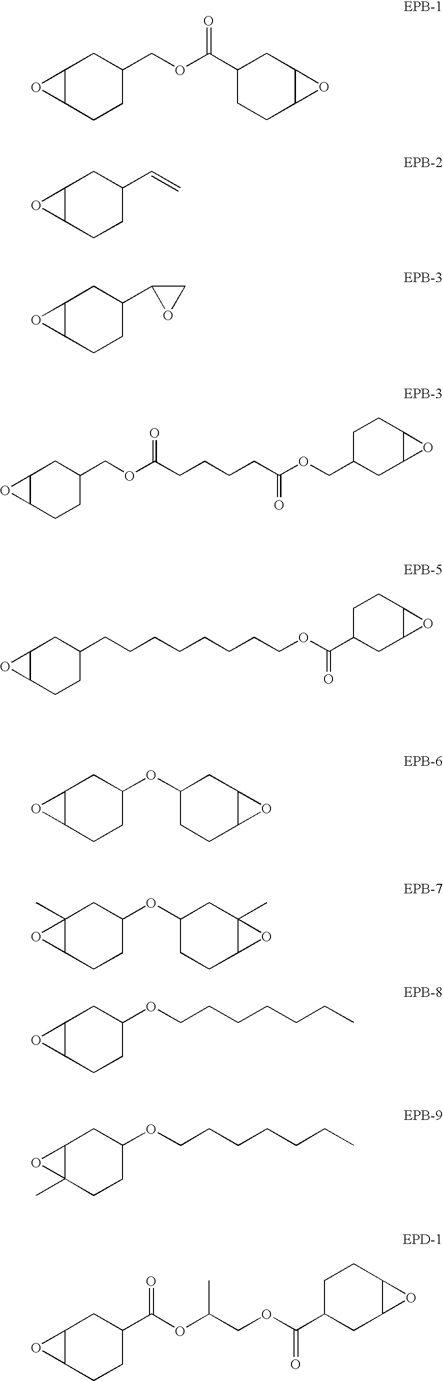

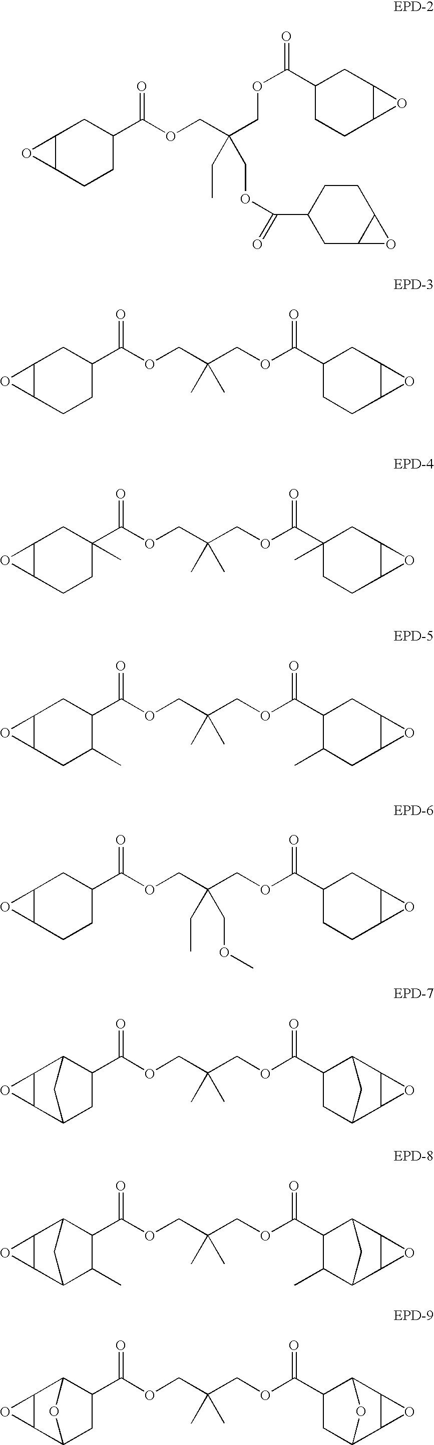

Examples, being usable in the present invention, of vegetable oils with epoxidized unsaturated bonds include oil products prepared by epoxidizing vegetable oils having unsaturated bonds such as olive oil, safflower oil, sunflower oil, soybean oil, and linseed oil. Further, epoxidized vegetable oils available on the market may be used. Examples include SANSOClZER-E-4030 manufactured by New Japan Chemical CO., Ltd., and Vf7010, Vf9010, and Vf9040 by ATOFINA Chemicals, Inc.

Further, compounds with the oxirane rings represented by above Formula (A) will now be described.

In above Formula (A), R₁₀₀ represents a substituent. Examples thereof include a halogen atom (for example, a chlorine atom, a bromine atom, and a fluorine atom), an alkyl group having 1-6 carbon atoms (for example, a methyl group, an ethyl group, a propyl group, an isopropyl group, and a butyl group), an alkoxy group having 1-6 carbon atoms (for example, a methoxy group, an ethoxy group, a n-propoxy group, an isopropoxy group, a n-butoxy group, and a tert-butoxy group), an acyl group (for example, an acetyl group, a propionyl group, and a trifluoroacetyl group), an acyloxy group (for example, an acetoxy group, a propionyloxy group, and a trifluoroacetoxy group), and an alkoxycarbonyl group (for example, a methoxycarbonyl group, an ethoxycarbonyl group, and a tert-butoxycarbonyl group). Preferred examples of the substituent include a halogen atom, an alkyl group, and an alkoxy group. m0 represents 0-2, but is preferably 0 or 1. r0 represents 1-3. L₀ represents a connecting group or a single bond. The connecting group has a branched structure with (r0+1) valence having 1 to 15 carbon atoms. The connecting group may have oxygen atoms or sulfur atoms in its main chain.

Further, compounds having the oxirane rings represented by above Formula (A) are preferably alicyclic epoxy compounds represented by following Formula (I) or (II) shown below.

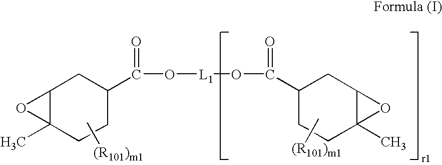

In above Formula (I), R₁₀₁ represents a substituent, and r1 represents 1-3. L₁ represents a connecting group or a single bond. The connecting group is a group with (r1+1) valence having 1 to 15 carbon atoms. The group may have oxygen atoms or sulfur atoms in its main chain.

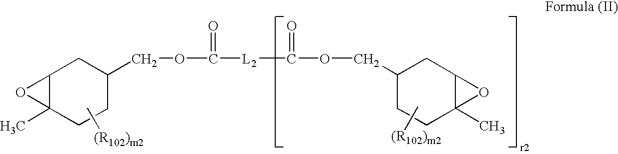

In above Formula (II), R₁₀₂ represents a substituent, and r2 represents 1-3. R₂ represents 1-3. L₂ represents a connecting group or a single bond. The connecting group is a group with (r2+1) valence having 1 to 15 carbon atoms. The group may have oxygen atoms or sulfur atoms in its main chain.

R₁₀₁ and R₁₀₂ each represented by above Formula (I) or (II) represent a substituent. Examples thereof include a halogen atom (for example, a chlorine atom, a bromine atom, and a fluorine atom), an alkyl group having 1-6 carbon atoms (for example, a methyl group, an ethyl group, a propyl group, an isopropyl group, and a butyl group), an alkoxy group having 1-6 carbon atoms (for example, a methoxy group, an ethoxy group, a n-propoxy group, an isopropoxy group, a n-butoxy group, and a tert-butoxy group), an acyl group (for example, an acetyl group, a propionyl group, and a trifluoroacetyl group), an acyloxy group (for example, an acetoxy group, a propionyloxy group, and a trifluoroacetoxy group), an alkoxycarbonyl group (for example, a methoxycarbonyl group, an ethoxycarbonyl group, and a tert-butoxycarbonyl group). Preferred examples of substituents include a halogen atom, an alkyl group, and an alkoxy group.

m1 and m2 each represent 0-2, but is preferably 0 or 1.

L₁ represents a connecting group or a single bond. The connecting group is a group with (r1+1) valence having 1 to 15 carbon atoms. The group may have oxygen atoms or sulfur atoms in its main chain. L₂ represents a connecting group or a single bond. The connecting group is a group with (r2+1) valence having 1 to 15 carbon atoms. The group may have oxygen atoms or sulfur atoms in its main chain.

Connecting groups represented by L₁, L₂, and L₃ are generally shown in above Formulas (A), (I), and (II). Examples of divalent connecting groups having 1-15 carbon atoms, which may have oxygen atoms or sulfur atoms in their main chain, include the groups described below. These groups may be combined with a plurality of groups of an —O— group, a —S— group, a —CO— group, and a —CS— group. The aforesaid divalent connecting groups are exemplified as follows:
methylene group: —CH₂—,
ethylidene group: >CHCH₃,
isopropylidene group: >C(CH₃)₂,
1,2-ethylene group: —CH₂CH₂—,
1,2-propylene group: —CH(CH₃)CH₂—,
1,3-propanediyl group: —CH₂CH₂CH₂—,
2,2-dimethyl-1,3-propanediyl group: —CH₂C(CH₃)₂CH₂—,
2,2-dimethoxy-1,3-propanediyl group: —CH₂C(OCH₃)₂CH₂—,
2,2-dimethoxymethyl-1,3-propanediyl group: —CH₂C(CH₂OCH₃)₂CH₂—,
1-methyl-1,3-propanediyl group: —CH(CH₃)CH₂CH₂—,
1,4-butanediyl group: —CH₂CH₂CH₂CH₂—,
1,5-pentanediyl group: —CH₂CH₂CH₂CH₂CH₂—,
oxydiethylene group: —CH₂CH₂OCH₂CH₂—,
thiodiethylene group: —CH₂CH₂SCH₂CH₂—,
3-oxothiodiethylene group: —CH₂CH₂SOCH₂CH₂—,
3,3-dioxothiodiethylene group: —CH₂CH₂SO₂CH₂CH₂—,
1,4-dimethyl-3-oxa-1,5-pentanediyl group: —CH(CH₃)CH₂O—CH(CH₃) CH₂—,
3-oxopentanediyl group: —CH₂CH₂COCH₂CH₂—,
1,5-dioxo-3-oxapentanediyl group: —COCH₂OCH₂CO—,
4-oxa-1,7-heptanediyl group: —CH₂CH₂CH₂OCH₂CH₂CH₂—,
3,6-dioxa-1,8-octanediyl group: —CH₂CH₂OCH₂CH₂OCH₂CH₂—,
1,4,7-trimethyl-3,6-dioxa-1,8-octanediyl group: —CH(CH₃) CH₂O—CH(CH₃) CH₂OCH(CH₃) CH₂—,
5,5-dimethyl-3,7-dioxa-1,9-nonanediyl group: —CH₂CH₂OCH₂C(CH₃)₂CH₂OCH₂CH₂—,
5,5-dimethoxy-3,7-dioxa-1,9-nonanediyl group: —CH₂CH₂OCH₂C(OCH₃)₂CH₂OCH₂CH₂—,
5,5-dimethoxymethyl-3,7-dioxa-1,9-nonanediyl group: —CH₂CH₂OCH₂C(CH₂OCH₃)₂CH₂OCH₂CH₂—,
4,7-dioxo-4,8-dioxa-1,10-decanediyl group: —CH₂CH₂O—COCH₂CH₂CO—OCH₂CH₂—,
4,8-dioxo-4,7-dioxa-1,10-decanediyl group: —CH₂CH₂CO—OCH₂CH₂O—COCH₂CH₂—,
1,3-cyclopentanediyl group: -1,3-C₅H₈—
1,2-cyclohexanediyl group: -1,2-C₆H₁₀—
1,3-cyclohexanediyl group: -1,3-C₆H₁₀—
1,4-cyclohexanediyl group: -1,4-C₆H₁₀—
2,5-tetrahydrofuranediyl group: 2,5-C₄H₆O—
p-phenylene group: -p-C₆H₄—
m-phenylene group: -m-C₆H₄—
α,α′-o-xylylene group: -o-CH₂—C₆H₄—CH₂—
α,α′-m-xylylene group: -m-CH₂—C₆H₄—CH₂—
α,α′-p-xylylene group: -p-CH₂—C₆H₄—CH₂—
furane-2,5-diyl-bismethylene group: 2,5-CH₂—C₄H₂O—CH₂—,
thiophene-2,5-diyl-bismethylene group: 2,5-CH₂—C₄H₂S—CH₂—, and
isopropylidenebis-p-phenylene group: -p-C₆H₄—C(CH₃)₂-p-C₆H₄—

Examples of the connecting groups, being trivalent or more, include groups formed by eliminating the necessary number of the hydrogen atoms which are located in any of the positions of the above-exemplified divalent connecting groups, and groups formed by combining these aforesaid groups with a plurality of groups of an —O— group, a —S— group, a —CO— group, and a —CS— group.

L₀, L₁ and L₂ each may have a substituent. Examples of the substituent include a halogen atom (for example, a chlorine atom, a bromine atom, and a fluorine atom), an alkyl group having 1-6 carbon atoms (for example, a methyl group, an ethyl group, a propyl group, an isopropyl group, and a butyl group), an alkoxy group having 1-6 carbon atoms (for example, a methoxy group, an ethoxy group, a n-propoxy group, an isopropoxy group, a n-butoxy group, and a tert-butoxy group), an acyl group (for example, an acetyl group, a propionyl group, and a trifluoroacetyl group), an acyloxy group (for example, an acetoxy group, a propionyloxy group, and a trifluoroacetoxy group), an alkoxycarbonyl group (for example, a methoxycarbonyl group, an ethoxycarbonyl group, and a tert-butoxycarbonyl group). Preferred examples of the substituents include an alkyl group, an alkoxy group, and an alkoxycarbonyl group.

Preferred examples of L₀, L₁ and L₂ include divalent connecting groups which may have oxygen atoms or sulfur atoms in their main chain. More preferred examples include divalent connecting groups have 1-5 carbon atoms. In these examples, the groups contain only carbon atoms in their main chain.

Specific examples of alicyclic epoxy compounds, represented by Formula (A), are listed below; however, the present invention is not limited thereto.

| | |
|---|---|
| EPC-1 | Molecular weight: 380.48 |
| 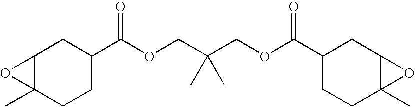 | |
| EPC-2 | Molecular weight: 366.45 |
| 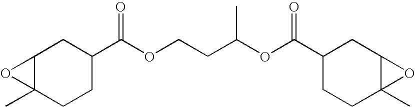 | |
| EPC-3 | Molecular weight: 434.52 |
| 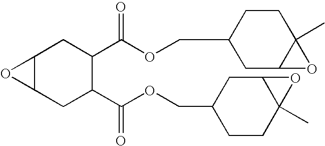 | |
| EPC-4 | Molecular weight: 352.42 |
| 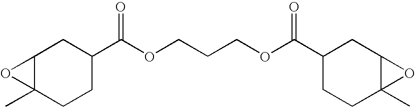 | |
| EPC-5 | Molecular weight: 338.40 |
| 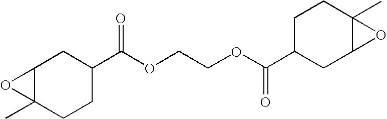 | |
| EPC-6 | Molecular weight: 380.48 |
| 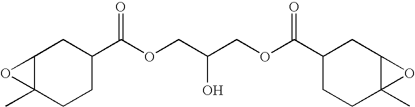 | |
| EPC-7 | Molecular weight: 352.42 |
| 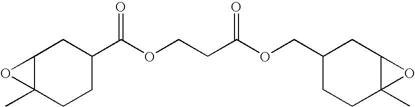 | |
| EPC-8 | Molecular weight: 338.40 |
| 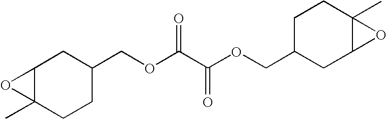 | |
| EPC-9 | Molecular weight: 352.42 |
| 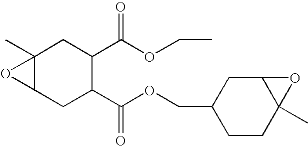 | |
| EPC-10 | Molecular weight: 338.40 |
| 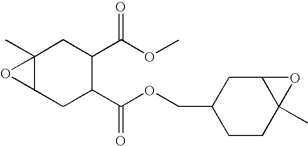 | |
| EPC-11 | Molecular weight: 352.42 |
| 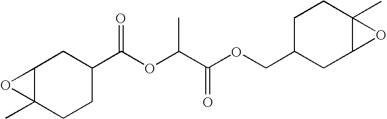 | |

It is desirable that the added amount of a compound having oxirane rings ranges from 10 to 80% by weight. In cases of less than 10% by weight, the prepared ink is unusable because the curing properties markedly vary depending on environments (temperature and humidity). In cases of more than 80% by weight, the ink is also unusable due to weakness of the film properties after curing. In the present invention, it is possible to independently use one kind of compound having oxirane rings, and also to properly join two or more kinds of compounds.

Further, production methods of the compounds having oxirane rings are not specified. They are synthesized by referring to the following literature: Yuki Gosei (Organic Synthesis) II of Zikken Kagaku Koza (Lecture on Experimental Chemistry) 20, 4th Edition, Pages 213—(published by Maruzen, 1992); The Chemistry of Heterocyclic Compounds—Small Ring Heterocycles, Part 3, Oxiranes edited by Alfred Hasfner (published by John & Wiley and Sons, An Interscience Publication, New York, 1985); Setsuchaku (Adhesion), Vol. 29, No. 12, Page 32, 1985, Vol. 30, No. 5, Page 42, 1986, and Vol. 30, No. 7, Page 42, 1986 written by Yoshimura; JP-A No. 11-100378, and Japanese Patent Publication Nos. 2906245 and 2926262.

One of the characteristics of compositions according to the present invention is that the compositions contain photolytically acid generating agents. Any of the above agents known in the art are available.

Compounds applied as chemically amplified photoresists, and to photo-cationic polymerization may be available as the photolytically acid generating agents (Refer to pages 187-192 of Imaging Yo Yuki Zairyo (Organic Materials Used for Imaging Applications) edited by Yuki Electronics Zairyo Kenkyukai (published by Bunshin Shuppan, 1993). Preferred examples of compounds in the present invention will now be listed below.

Firstly preferred examples include B(C₆F₅)₄⁻, PF₆⁻, AsF₆⁻, SbF₆⁻, and CF₃SO₃⁻ salts of aromatic onium compounds having a diazonium group, an ammonium group, an iodonium group, a sulfonium group, and a phosphonium group.

Specific examples available in the present invention are listed below.

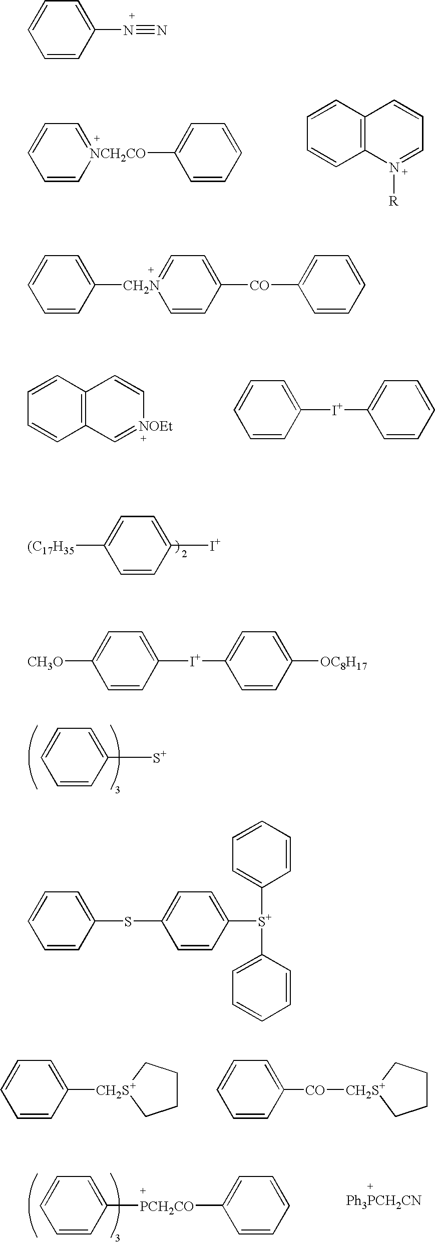

Secondly preferred examples include sulfone compounds which generate sulfuric acid. These specific examples are listed below.

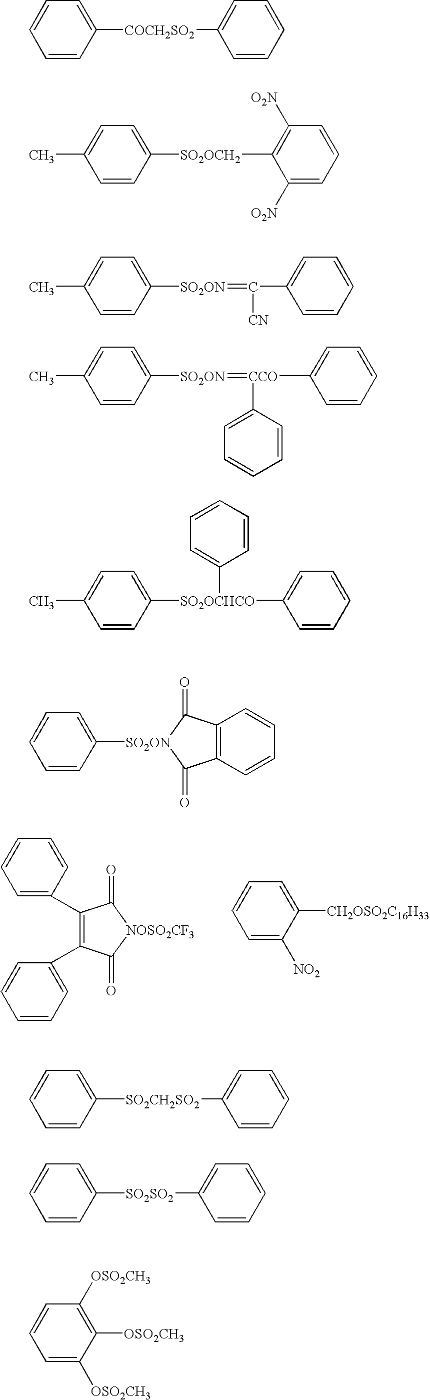

Thirdly preferred examples also include halides which photolytically generate hydrogen halides. These specific examples are listed below.

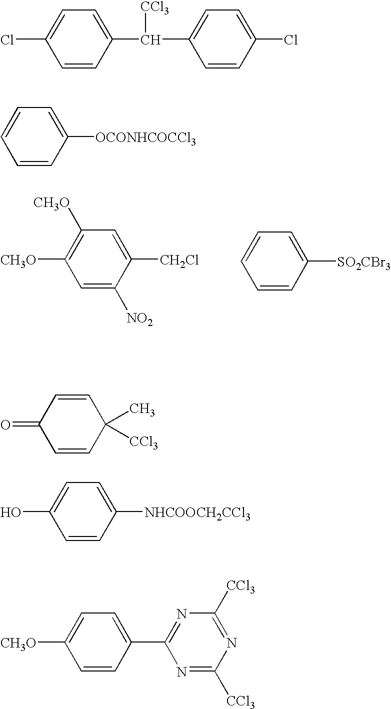

Fourthly preferred examples include iron allene complexes listed below.

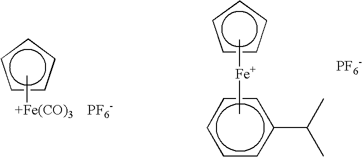

Further, preferred examples of the compositions according to the present invention include the sulfonium compounds represented by following Formulas (1)-(4), which do not generate benzene via actinic light exposure. The sulfonium compounds having a substituent in the benzene ring, which joins a S⁺, meet the above condition.

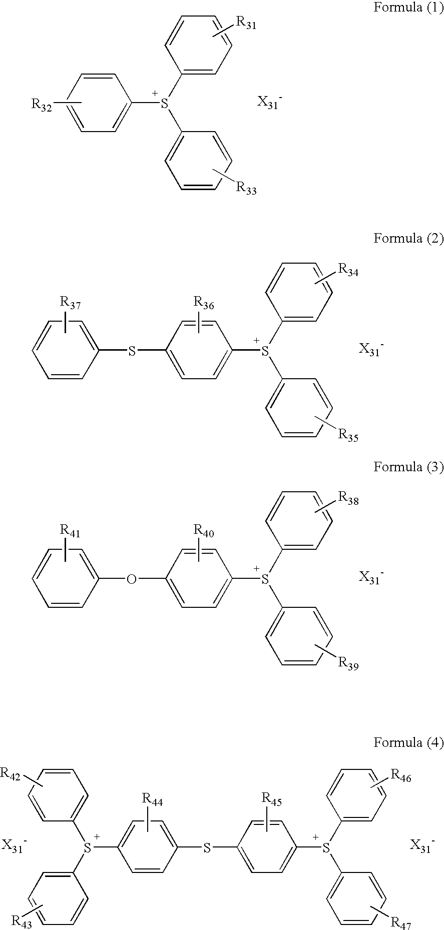

In above Formulas (1)-(4), R₃₁-R₄₇ each represent a hydrogen atom, or a substituent. R₃₁-R₃₃, R₃₄-R₃₇, R₃₈-R₄₁, and R₄₂-R₄₇ each do not represent a hydrogen atom simultaneously.

Preferred examples of the substituent represented by R₃₁-R₄₇ include an alkyl group (for example, a methyl group, an ethyl group, a propyl group, an isopropyl group, a butyl group, an isobuthyl group, a tert-butyl group, a pentyl group, and a hexyl group), an alkoxy group (for example, a methoxy group, an ethoxy group, a propoxy group, a butoxy group, a hexyloxy group, a decyloxy group, and a dodecyloxy group), a carbonyl group (for example, an acetoxy group, a propionyloxy group, a decylcarbonyloxy group, a dodecylcarbonyloxy group, a methoxycarbonyl group, an ethoxycarbonyl group, and a benzoyloxy group), a phenylthio group, a halogen atom (for example, a fluorine atom, a chlorine atom, a bromine atom, and an iodine atom), a cyano group, a nitro group, and a hydroxyl group.

X₃₁ represents a non-nucleophilic anion residue. Examples of X₃₁ include a halogen atom (for example, a fluorine atom, a chlorine atom, a bromine atom, and an iodine atom), B (C₆F₅)₄, R₁₈COO, R₁₉SO₃, SbF₆, AsF₆, PF₆, and BF₄. However, R₁₈ and R₁₉ each represent an alkyl group, or a phenyl group which may be substituted by an alkyl group (for example, a methyl group, an ethyl group, a propyl group, and a butyl group), a halogen atom (for example, a fluorine atom, a chlorine atom, a bromine atom, and an iodine atom), a nitro group, a cyano group, and an alkoxy group (for example, a methoxy group, and an ethoxy group). Among these non-nucleophilic anion residues, B(C₆F₅)₄ and PF₆ are preferable in view of safety.

The above-described compounds are readily synthesized by methods known in the art in the same manner as for the photolytically acid generating agents described in Bulletin of The Chemical Society of Japan, Vol. 71, No. 11, 1998, and Imaging Yo Yuki Zairyo (Organic Materials Used for Imaging Applications) edited by Yuki Electronics Zairyo Kenkyukai published by Bunshin Shuppan (1993).

In the present invention, it is specifically preferable that the sulfonium salts represented by above Formulas (1)-(4) be at least one of sulfonium salts selected from following Formulas (5)-(13) shown below. X₃₁ represents a non-nucleophilic anion residue as described above.

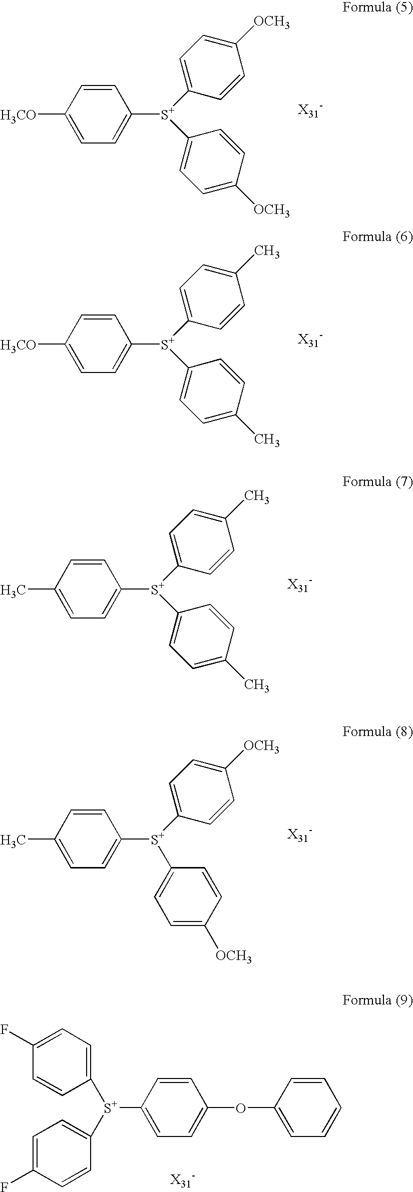

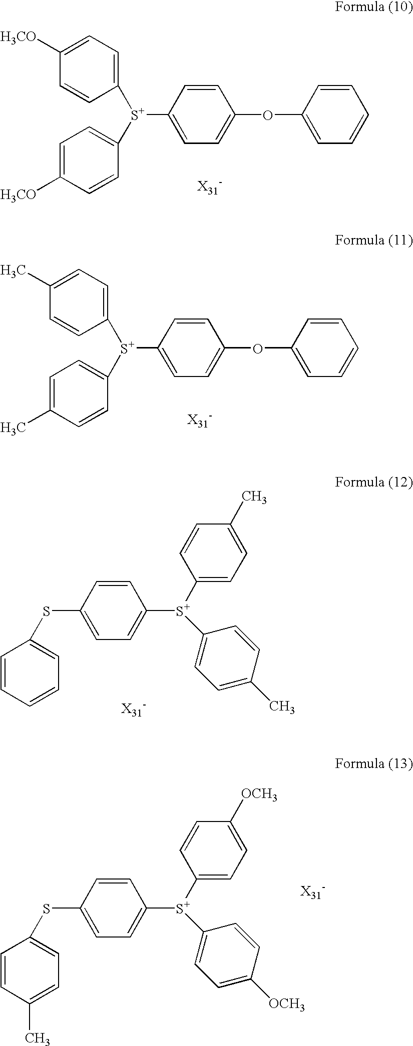

Benzimidazolone derivatives may be produced by methods known in the art such as a method of reacting with sulfuric acid, and the methods described in JP-A Nos. 2002-241638 and 2002-285067.

Examples of the benzimidazolone derivatives include the compounds represented by above Formula (B1), and by following Formulas (B2) and (B3).
P_{b2}—(X_{b}—NR_{b1}R_{b2})ₙ₄ Formula (B2)
wherein P_{b2} represents a benzimidazolone pigment residue; X_{b} represents a divalent connecting group; R_{b1} and R_{b2}, which may differ, represent a hydrogen atom or an alkyl group. R_{b1} and R_{b2} may join to form a ring. The above ring may contain hetero atoms; and n4 represents an integer of 1-2.

Examples of X_{b} include a —SO₂— group, a —CO— group-, and a —CH₂— group. Examples of R_{b1} and R_{b2} include a methyl group, an ethyl group, a piperidinomethyl group, a dimethylaminomethyl group, a diethylamioethyl group, a dimethylaminopropyl group, a diethylaminopropyl group, a dibuthylaminopropyl group, a piperidinoethyl group, a morpholinoethyl group, a piperidinopropyl group, a diethylaminohexyl group, diethylaminoetoxypropyl group, a diethylaminobuthyl group, a dimethylaminoamyl group, a 2-ethylhexylaminoethyl group, a stearylaminoethyl group, an oleylaminoethyl group, a p-dimethylaminoethylsulfamoylphenyl group, a p-diethylaminoethylsulfamoylphenyl group, a p-dimethylaminopropylsulfamoylphenyl group, and a p-diethylaminoethylcarbamoylphenyl group.
P_{b3}—(N═N—Ph-Z_{b})ₙ₅ Formula (B3)
wherein P_{b3} represents a benzimidazolone pigment residue; Z_{b} represents an amino group, a carboxylic acid group and a salt thereof, a sulfonic acid group and a salt thereof, a carbamoyl group which may be substituted, and a sulfamoyl group which may be substituted; and n5 represents an integer of 1-2.

Examples of Z_{b} include an amino group which may be substituted (for example, an amino group, a methylamino group,

an ethylamino group, a dimethylamino group, a diethylamino group, a 2-ethylhexylamino group), an anilino group, a carboxylic acid group and a salt thereof, a carbamoyl group, a methylcarbamoyl group, a dimethylcarbamoyl group, an ethylcarbamoyl group, a diethylcarbamoyl group, a sulfamoyl group, a methylsulfamoyl group, an ethylsulfamoyl group, a dimethylsulfamoyl group, and a diethylsulfamoyl group.

Preferred examples of the benzimidazolone derivatives include the compounds represented by above Formula (B1). Benzimidazolone pigments are prepared, for example, by the following methods: Firstly, a benzimidazolone derivative may be added at the time of dispersion; and secondly, a benzimidazolone derivative is dissolved in a solvent, and then a pigment is added into the resultant solution to form a suspension. The product obtained by removing the solvent from the suspension may be used as a benzimidazolone pigment.

It is preferable that the added amount of the benzimidazolone derivative ranges from 0.1 to 20% by weight in view of solidity. The range from 1 to 10% by weight is more preferable.

Though polymerizable monomers are non-polar solvents, the groups related to polymerization exhibit polarity. Since both non-polar interaction and polar interaction are under action, it is difficult to stabilize dispersion. When dispersion stability is insufficient, clogging of nozzles of a recoding head and generation of structural viscosity due to precipitation result. During ink-jet recording, generation of structural viscosity results in an increase in viscosity of the ink at the intermittent ejection, resulting in poor ejection such as a decrease in the ejection rate. Specifically, decrease in the ejection rate results in the following problems. In an ink-jet recording apparatus fitted with a carriage, for example, in bidirectional printing, during the period of returning of the carriage, the viscosity of the ink increases, whereby the deposition position of ink droplets which is continuously ejected from the nozzle shifts from the deposition position of the ink droplets ejected from the nozzle which has not been employed. To stabilize the dispersion, it is possible to consider an increase in the amount of dispersing agents. However, the excessive amount of the dispersing agents results in instability of ink ejection.

The above instability is assumed to be as follows. Dispersing agents in an excessive amount vary wettability of the area near the nozzles.

Further, in the ink employing cationically polymerizable monomers, photolytically generated acids progress polymerization. Pigments and dispersing agents are subjected to adhesion via a polar mutual interaction such as an acid-base. Consequently, it is assumed that an increase in the amount of dispersing agents results in an increase of the polar group derived from dispersing agents in the curing reaction system, resulting in trapping of the photolytically generated acids. It is assumed that benzimidazolone derivatives function as a dispersing aid and play a role to allow dispersing agents to efficiently adsorb onto pigments, and as a result, it is possible to realize targeted dispersion stability without degrading curability.

In JP-A Nos. 2002-241638 and 2002-285067, benzimidazolone derivatives are employed in water based dispersions. However, the inventors of the present invention discovered that they were effective even in non-water based dispersions.

Further, to improve storage stability, it is possible to employ any of the appropriate basic compounds known in the art. Representative compounds include basic alkaline metal compounds, basic alkaline earth metal compounds, and basic organic compounds such as amine.

Basic alkaline metal compounds include alkaline metal hydroxides (lithium hydroxide, sodium hydroxide, and potassium hydroxide), alkaline metal carbonates (lithium carbonate, sodium carbonate, and potassium carbonate), alkaline metal alcolates (sodium methoxide, sodium ethoxide, potassium methoxide, and potassium ethoxide).

Basic alkaline earth metal compounds include alkaline earth metal hydroxides (magnesium hydroxide and calcium hydroxide), alkaline earth metal carbonates (magnesium carbonate and calcium carbonate), and alkaline earth metal alcolates (magnesium methoxide).

Basic organic compounds include nitrogen containing heterocyclic ring compounds such as amines, quinoline, or quinolizine. Of these, from the aspect of compatibility with photopolymerizable monomers, amines are preferred and examples include octylamine, naphthylamine, xylenediamine, dibenzylamine, diphenylamine, dibutylamine, dioctylamine, dimethylaniline, quinuclidine, tributylamine, trioctylamine, tetramethylethylenediamine, tetramethyl-1,6-hexamethylenediamine, hexamethylenetetramine, and triethanolamine.

When basic compounds are allowed to be present, the concentration is preferably in the range of 10-1,000 ppm by weight, but is most preferably in the range of 20-500 ppm by weight. Basic compounds may be employed individually or in combinations of a plurality of them.

Further, in order to retard curing of ink in the ink tank, the piping, and the head, water may be incorporated. The added amount of water is preferably 0.1-8% by weight with respect to the total compositions.

Still further, by combining radically polymerizable monomers with initiators, it is possible to prepare a radical/cation hybrid type curable ink.

In order to stabilize ejection from the ink-jet head and to realize targeted curability irrespective of the curing ambience (temperature and humidity), viscosity of the actinic radiation curable ink-jet ink is preferably 7-50 mPa·s at 25° C.

Other those described above, various additives may be incorporated in the actinic radiation curable ink-jet ink of the present invention. For example, incorporated may be surface active agents, leveling additives, matting agents, polyester based resins, polyurethane based resins, vinyl based resins, acryl based resins, and rubber based resins all of which control physical properties of film, and various waxes.

Other than common non-coated paper and coated paper, as recording materials in the present invention, employed may be various non-absorptive plastics and films thereof, which are employed for so-called light-weight packaging. Examples of various usable plastic films include PET film, OPS film, OPP film, ONy film, PVC film, and TAC film. Employed as other plastics may be polycarbonate, acrylic resins, ABS, polyacetal, PVA, and rubber. Further, metals and glass may be applicable.

The surface energy of these various plastic films significantly differs, whereby, heretofore, problems have occurred in which dot diameter varies after deposition of ink droplets depending on recording materials. However, the embodiments of the present invention enable formation of high definition images onto recording materials which exhibit a wide variation of surface energy of 35-60 mN/m, such as OPP film and OPS exhibiting a relatively low surfce energy, as well as PET film exhibiting a relatively high surface energy.

In the present invention, in view of capability to correspond to the recording material cost such as packaging cost or production cost, the print production efficiency, and the adaptability to various size prints, the use of long-length (web) recording materials is advantageous.

It is possible to employ the actinic radiation curable ink-jet ink of the present invention in the form of a set together with inks incorporating different p colored pigments. It is preferable that the above inks are employed in the form of a set of a plurality of inks such as an ink-jet ink set composed of at least a yellow ink-jet ink, a magenta ink-jet ink, and a black ink-jet ink, which is commonly employed to prepare so-called color ink-jet prints.

Further, to form photographic images employing ink-jet printing, so-called dark and light inks in which the content of colorants is varied in each ink. In terms of color reproduction, if desired, it is preferable to employ special colored inks such as red, green, blue, or white ink.

The image forming method of the present invention will now be described.

The image forming method of the present invention is one in which images are formed by discharging the above inks onto a recording material via an ink-jet recording system and subsequently, inks are cured via exposure to actinic radiation such as UV radiation.

(Ink Layer Thickness after Deposition of Ink Droplets)

In the present invention, it is preferable that the total ink layer thickness after deposition of ink droplets on a recording material and curing via exposure to actinic radiation is preferably 2-25 μm. In the actinic radiation curable type ink-jet recording in the screen printing field, at present, the total ink layer thickness exceeds 25 μm. In the soft-package printing field, in which thin plastic materials are frequently employed as a recording material, in addition of the above problems such as curling and wrinkling of the recording materials, problems occur in which stiffness and feel of quality of entire printed matter are varied. Consequently, ink discharge which results in an excessively thick layer is not preferred.

“Total ink layer thickness”, as described herein, refers to the maximum value of the ink layer thickness of the image recorded on the recording material. The above total ink layer thickness is as defined for cases in which recording is conducted via a single color ink-jet recording system, as well as 2-color superimposition (secondary color), 3-color superimposition, and 4-color superimposition (white ink base).

(Ink Discharge Conditions)

To realize discharge stability, preferred discharge conditions are that the recording head and ink are heated at 35-100° C. The actinic radiation curable type ink results in a wide variation of viscosity depending on the change of temperature. Viscosity variation significantly affects the size of ink droplets and the rate of droplet ejection, resulting in degradation of image quality. Accordingly, it is necessary to raise ink temperature and maintain at a constant value. The ink temperature is controlled commonly within specified temperature ±5° C., preferably within specified temperature ±2° C., but still more preferably ±1° C.

Further, in the present invention, the droplet volume, discharged from each nozzle fitted with the ink-jet recording head, is 2-20 pl. In order to form high definition images, the droplet volume is required to be in the above range. However, when the above droplet volume is discharged, the above discharge stability is particularly demanded. According the present invention, even though discharge of tiny droplets at a volume of 2-20 pl is conducted, discharge stability is enhanced, and enables the stable formation of high definition images.

(Radiation Exposure Conditions after Deposition of Ink Droplets)

In the image forming method of the present invention, actinic radiation exposure conditions are as follows. Actinic radiation is exposed preferably 0.001-1 second after deposition of ink droplets, but is exposed more preferably 0.001-0.5 second. In order to form high definition images, it is particularly critical that exposure timing is as soon as possible.

The basic method of actinic radiation exposure methods is disclosed in JP-A No. 60-132767. Based on that, radiation sources are arranged on both sides of the head unit, and the head and the radiation source are scanned via a shuttle system. Exposure is conducted within a specified period after deposition of ink droplets. Further, curing is completed via another radiation source which is not driven. U.S. Pat. No. 145,979 discloses, as an exposure method, one which employs optical fiber and another in which UV radiation is exposed to a recording section via hitting collimated radiation onto a mirror surface provided on the side of the unit. In the image forming method of the present invention, either of these exposure methods may be usable.

Further, the following method is one of the preferred embodiments. Radiation exposure is divided into two stages. Initially, actinic radiation is exposed within 0.001-2 seconds after deposition of ink droplets, and after complete printing, actinic radiation is further exposed. By dividing actinic radiation exposure into two stages, it is possible to retard contraction of the recording material, which occurs during ink curing.

Heretofore, it has been common that a high illuminance radiation source, which consumes total power of at least 1 kW-hour, is employed to retard dot widening and bleeding after deposition of ink droplets. However, when such a radiation source is employed, particularly in shrink label printing, the contraction of recording materials is too large, whereby it has been impossible to employ the above radiation source.

In the present invention, it is preferable to employ actinic radiation having a maximum illuminance in the wavelength region of 354 nm. Even though radiation source which consumes the total power of at least 1 kW·hour, it is possible to form high definition images and to control the contraction of recording materials within the practically acceptable level.

In the present invention, it is further preferable that the total consumption power of the radiation source, which emits actinic radiation, is less than 1 kW·hour. Examples of radiation sources, which consume power less than 1 kW hour, include fluorescent lamps, cold-cathode tubes and LEDs; however, the present invention is not limited thereto.

The recording apparatus of the present invention will now be described while appropriately referring to drawings. The recording apparatus in the drawings is one embodiment of the present inventions, and the recording apparatus of the present invention is not limited to those in the drawings.

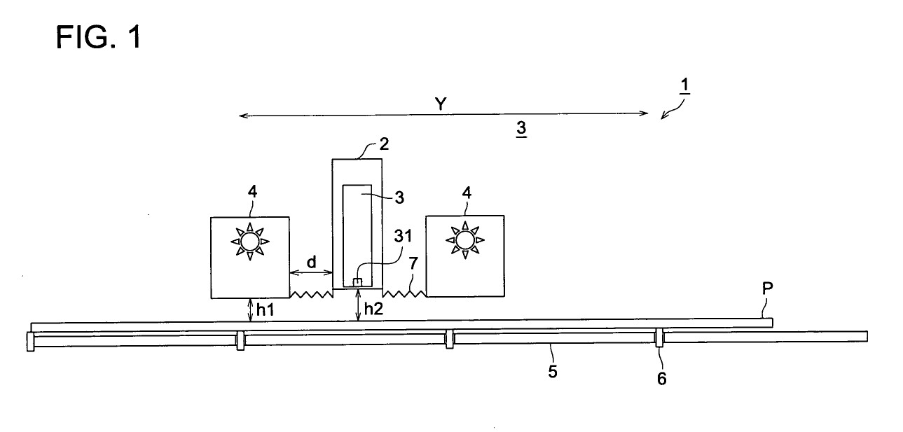

FIG. 1 is a front view showing the structure of the main section of the recording apparatus of the present invention. Recording apparatus 1 is structured by being provided with head carriage 2, recording head 3, exposure means 4, and platen section 5. In this recording apparatus 1, the platen section 5 is arranged under the recording material P. Platen section 5 has a function absorbing UV radiation and absorbs extra UV radiation which has passed through recording material P. As a result, it is possible to very stably reproduce high definition images.

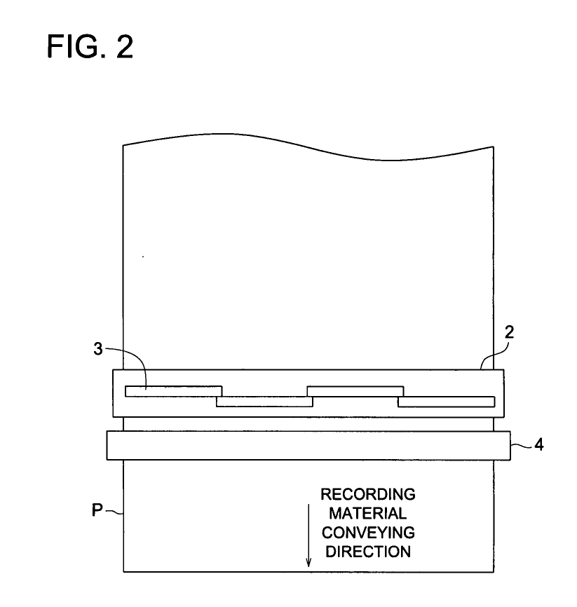

Recording material P is guided by guide member 6 and is conveyed from the front to the rear in FIG. 1 via the operation of conveying means (not shown). Head scanning means (not shown) allows head carriages 2 to reciprocate in Y direction in FIG. 2, whereby scanning of recording head 3 held by carriage 2 is conducted.

Head carriage 2 is arranged above recording material P, and a plurality of recording heads 3, described below, corresponding to the number of colors employed for image printing on recording material P is housed while the discharge orifice is arranged in the lower side. Carriage 2 is arranged for recording apparatus 1 main body capable of realizing reciprocation in the Y direction of FIG. 1, and via driving of the head scanning means, reciprocation in the Y direction of FIG. 1 is conducted.

FIG. 1 is drawn so that head carriage 2 houses recording head 3. In practice, the number of colors of recording head 3 housed in head carriage 2 is appropriately determined.

Recording head 3 discharges an actinic radiation curable ink (for example, a UV curable ink) supplied by an ink supplying means (not shown) onto recording material P via action of a plurality of discharge means (not shown) provided in the interior. The UV ink discharged from recording head 3 is composed of colorants, polymerizable monomers and initiators, and exhibits a property such that when exposed to UV radiation, the initiators function as a catalyst, whereby curing results via crosslinking and polymerization reaction of the monomers.

Recording head 3 moves from one end of recording material P to the other end in the Y direction in FIG. 1, while driven by a scanning means. During scanning performed by the above movement, the UV ink is discharged onto the specified area (being the deposition applicable area) in recording material P in the form of ink droplets, and the ink droplets are deposited onto the above deposition applicable area.

The recording apparatus of the present invention will now be described while referring to d appropriate drawings. The recording apparatus in the drawings is one embodiment of the recording apparatus of the present invention, and the recording apparatus of the present invention is not limited thereto.

FIG. 1 is a front view showing the structure of the main section of the recording apparatus of the present invention. Recording apparatus 1 is structured by being provided with head carriage 2, recording head 3, exposure means 4, and platen section 5. In this recording apparatus 1, the platen section 5 is arranged under the recording material P. The platen section 5 has a function absorbing UV radiation and absorbs extra UV radiation which has passed through recording material P. As a result, it is possible to very stably reproduce high definition images.

Recording material P is guided by guide member 6 and is conveyed from the front to the rear in FIG. 1 via the operation of conveying means (not shown). A head scanning means (not shown) allows head carriages 2 to reciprocate in the Y direction in FIG. 2, whereby scanning of recording head 3 held by carriage 2 is conducted.

Head carriage 2 is arranged on the upper side of recording material P, and a plurality of recording heads 3, described below, corresponding to the number of colors employed for image printing on recording material P is housed while the discharge orifice is arranged in the lower side. Carriage 2 is arranged for recording apparatus 1 main body capable of realizing reciprocation in the Y direction of FIG. 1, and via driving of the head scanning means, reciprocation in the Y direction of FIG. 1 is conducted.

FIG. 1 is drawn so that head carriage 2 houses recording head 3. In practice, the number of colors of recording head 3 housed in head carriage 2 is appropriately determined.

Recording head 3 discharges an actinic radiation curable type ink (for example, a UV curing ink) supplied by the ink supplying means (not shown) onto recording material P via action of a plurality of discharge means (not shown) provided in the interior. The UV ink discharged from the recording head 3 is composed of colorants, polymerizable monomers, and initiators and exhibits property such that when exposed to UV radiation, the initiators function as a catalyst, whereby curing results via crosslinking and polymerization reaction of the monomers.

Recording head 3 moves from one end of recording material P to the other end in the Y direction in FIG. 1, while driven by the scanning means. During scanning performed by the above movement, the UV ink is discharged onto a specified area (being the deposition applicable area) in recording material P in the form of ink droplets, and the ink droplets are deposited onto the above deposition applicable area.

It is possible to appropriately change the wavelength of UV radiation for exposure via exposure means 4 by changing the UV radiation lamp or the filter.

The ink of the present invention exhibits very high discharge stability and is particularly useful in the case in which images are formed employing a line head type recording apparatus.

FIG. 2 is a top view showing another example of the structure of the main section of an ink-jet recording apparatus.

The ink-jet recording apparatus shown in FIG. 2 is called a line head system apparatus, and a plurality of ink-jet recording heads for each color is fixedly arranged in head carriage to cover the entire width of recording material P.

On the other hand, exposure means 4 usable for the entire width of recording material P is similarly arranged to cover the entire region for the ink printing plane. Employed as the UV radiation lamp used in exposure means 4 may be ones which are the same as those described in FIG. 1.

In the above line head system, head carriage 2 and exposure means 4 are fixed and recording material is only conveyed, followed by ink ejection and curing for image formation.

### EXAMPLES

The present invention will now be specifically described with reference to examples; however, the present invention is not limited thereto.

### Example 1

### Preparation of Pigment Dispersions

(Preparation of Pigment Dispersion D-1)

Each of the following compounds is placed in a stainless steel beaker, and while stirring, dissolution was conducted over one hour while heated on a hot plate at 50° C.

| | | |
|---|---|---|
| SOLSPERSE 24000GR (being a polymer dispersing agent | 5 | parts |
| at an amine value of 35.9 mg KOH/g, produced by | | |
| Avicia Ltd.) | | |
| OXT221 (being an oxetane compound, produced by | 84.2 | parts |
| TOAGOSEI Co., Ltd.) | | |

Subsequently, after cooling the above solution to room temperature, the following pigment was added to the cooled solution, and the resulting mixture was sealed in a polypropylene vessel together with 100 g of diameter 0.5 mm zirconia beads, followed by dispersion for 6 hours, employing a paint shaker. Thereafter, zirconia beads were removed, whereby Pigment Dispersion D-1 was prepared.

| | | |
|---|---|---|
| C.I. Pigment Yellow 120 | 10 | parts |
| Benzimidazolone Derivative Y-1 | 0.8 | part |

(Preparation of Pigment Dispersion D-2)

Each of the following compounds was placed in a stainless steel beaker, and while stirring, dissolution was conducted over one hour while heated on a hot plate at 50° C.

| | | |
|---|---|---|
| SOLSPERSE 24000GR (being a polymer dispersing agent | 6 | parts |
| at an amine value of 35.9 mg KOH/g, produced by | | |
| Avicia Ltd.) | | |
| OXT211 (being an oxetane compound, produced by | 83 | parts |
| TOAGOSEI Co., Ltd.) | | |

Subsequently, after cooling the above solution to room temperature, the following pigment was added to the cooled solution, and the resulting mixture was sealed in a polypropylene vessel together with 100 g of diameter 0.5 mm zirconia beads, followed by dispersion for 6 hours, employing a paint shaker. Thereafter, zirconia beads were removed, whereby Pigment Dispersion D-2 was prepared.

| | | |
|---|---|---|
| C.I. Pigment Yellow 180 | 10 | parts |
| Benzimidazolone Derivative Y-2 | 1 | part |

(Preparation of Pigment Dispersion D-3)

Each of the following compounds was placed in a stainless steel beaker, and while stirring, dissolution was conducted over one hour while heated on a hot plate at 50° C.

| | | |
|---|---|---|
| SOLSPERSE 32000 (being a polymer dispersing agent | 5 | parts |
| at an amine value of 27.1 mg KOH/g, produced by | | |
| Avicia Ltd.) | | |
| OXT211 (being an oxetane compound, produced by | 84.5 | parts |
| TOAGOSEI Co., Ltd.) | | |

Subsequently, after cooling the above solution to room temperature, the following pigment was added to the cooled solution, and the resulting mixture was sealed in a polypropylene vessel together with 100 g of diameter 0.5 mm zirconia beads, followed by dispersion for 6 hours, employing a paint shaker. Thereafter, zirconia beads were removed, whereby Pigment Dispersion D-3 was prepared.

| | | |
|---|---|---|
| C.I. Pigment Yellow 151 | 10 | parts |
| Benzimidazolone Derivative Y-3 | 0.5 | part |

(Preparation of Pigment Dispersion D-4)

Each of the following compounds was placed in a stainless steel beaker, and while stirring, dissolution was conducted over one hour while heated on a hot plate at 50° C.

| | | |
|---|---|---|
| SOLSPERSE 32000 (being a polymer dispersing agent | 4 | parts |
| at an amine value of 27.1 mg KOH/g, produced by | | |
| Avicia Ltd.) | | |
| OXT211 (being an oxetane compound, produced by | 86 | parts |
| TOAGOSEI Co., Ltd.) | | |

Subsequently, after cooling the above solution to room temperature, the following pigment was added to the cooled solution, and the resulting mixture was sealed in a polypropylene vessel together with 100 g of diameter 0.5 mm zirconia beads, followed by dispersion for 6 hours, employing a paint shaker. Thereafter, zirconia beads were removed, whereby Pigment Dispersion D-4 was prepared.

| | |
|---|---|
| C.I. Pigment Yellow 151 | 10 parts |

(Preparation of Pigment Dispersion D-5)

Each of the following compounds was placed in a stainless steel beaker, and while stirring, dissolution was achieved over one hour while heated on a hot plate at 50° C.

| | |
|---|---|
| SOLSPERSE 24000GR (being the polymer dispersing agent | 15 parts |
| at an amine value of 35.9 mg KOH/g, produced by | |
| Avicia Ltd.) | |
| OXT212 (being the oxetane compound, produced by | 75 parts |
| TOAGOSEI Co., Ltd.) | |

Subsequently, after cooling the above solution to room temperature, the following pigment was added to the cooled solution, and the resulting mixture was sealed in a polypropylene vessel together with 100 g of diameter 0.5 mm zirconia beads, followed by dispersion for 6 hours, employing a paint shaker. Thereafter, zirconia beads were removed, whereby Pigment Dispersion D-5 was prepared.

| | |
|---|---|
| C.I. Pigment Yellow 120 | 10 parts |

SY-1

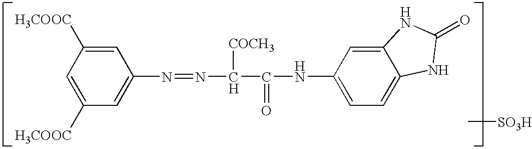

SY-2

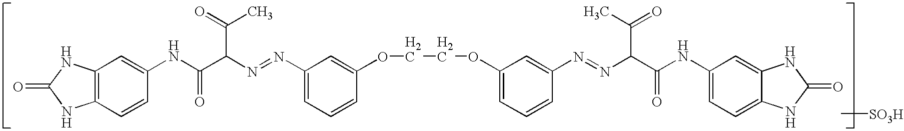

SY-3

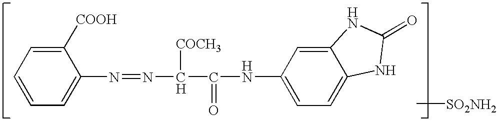

<<Preparation of Ink Compositions>>

Each of the additives, described in Table 1, was sequentially mixed, and the resulting mixture was filtered through a 1.0 μm membrane filter, whereby Inks 1-17 were prepared. The numeric values described in Table 1 are in % by weight.

TABLE 1

| | Colorant | | | | | | | | | | |
|---|---|---|---|---|---|---|---|---|---|---|---|
| | Pigment | | | | Compound Having an Oxirane Ring | | | | Photolytically | Surface | |
| | Dispersion | | Oxetane | | 1 | | 2 | | Acid Generating | Active | |
| Ink | | Added | Compound | | | Added | | Added | Compound | Agent | |
| No. | No. | amount | OXT221 | OXT212 | Type | amount | Type | amount | SP-152 | F475 | Remarks |
| 1 | D-1 | 30.00 | 40.54 | | EPA-7 | 29.00 | | | 0.45 | 0.01 | Inv. |
| 2 | D-1 | 33.00 | 39.49 | | EPB-1 | 27.00 | | | 0.50 | 0.01 | Inv. |
| 3 | D-1 | 34.00 | 40.49 | | PO | 25.00 | | | 0.50 | 0.01 | Inv. |
| 4 | D-1 | 32.00 | | 40.46 | DEP | 27.00 | | | 0.52 | 0.02 | Inv. |
| 5 | D-1 | 28.00 | 38.11 | | E-4030 | 33.40 | | | 0.48 | 0.01 | Inv. |
| 6 | D-1 | 31.50 | 39.15 | | EPC-1 | 28.90 | | | 0.45 | | Inv. |
| 7 | D-2 | 31.00 | 28.05 | 11.00 | EPD-9 | 29.50 | | | 0.44 | 0.01 | Inv. |
| 8 | D-2 | 32.00 | 35.98 | | PO | 4.50 | EPC-1 | 27.00 | 0.50 | 0.02 | Inv. |
| 9 | D-2 | 29.50 | 38.97 | | EPC-1 | 31.00 | | | 0.52 | 0.01 | Inv. |
| 10 | D-2 | 27.00 | | 43.53 | EPB-1 | 29.00 | | | 0.45 | 0.02 | Inv. |
| 11 | D-3 | 31.00 | 37.55 | | EPD-7 | 31.00 | | | 0.44 | 0.01 | Inv. |
| 12 | D-4 | 28.00 | 43.50 | | EPB-1 | 28.00 | | | 0.48 | 0.02 | Comp. |
| 13 | D-4 | 31.00 | 43.48 | | DEP | 25.00 | | | 0.50 | 0.02 | Comp. |
| 14 | D-4 | 30.50 | 31.97 | 10.00 | E-4030 | 27.00 | | | 0.51 | 0.02 | Comp. |
| 15 | D-4 | 32.00 | 37.54 | | E-4030 | 30.00 | | | 0.45 | 0.01 | Comp. |
| 16 | D-5 | 31.00 | 43.65 | | EPB-1 | 25.00 | | | 0.35 | | Comp. |
| 17 | D-5 | 33.00 | 33.49 | | E-4030 | 33.00 | | | 0.50 | 0.01 | Comp. |

Inv.: Present Invention,
Comp.: Comparative Example

Each of the additives which are abbreviated in Table 1 will be detailed.

(Compounds Having an Oxirane Ring)

PO: 1, 2:8,9-diepoxylimonene

E-4030: SANSOClZER E-4030 (epoxidized butyl aliphate, produced by New Japan Chemical Co., Ltd.)

(Photolytically Acid Generating Compound)

SP-152: triphenylsulfonium salt (“ADEKA OPTOMER SP-152”, produced by Asahi Denka Co., Ltd.)

(Surface Active Agent)

F475: MEGAFAX F475 perfluoroalkyl group containing acryl oligomer (produced by Dainippon Ink and Chemicals, Inc.)<

<Image Forming Method A>>

Each of Inks 1-17, prepared as above, was loaded into a carriage system ink-jet recording apparatus, structured as described in FIG. 1, provided with a piezo type ink-jet nozzles. Subsequently, a solid yellow image was continuously printed onto a 500 m long-length polyethylene phthalate film at a thickness of 120 μm and a width of 600 nm, where by each image was prepared. The ink supply system was composed of an ink tank, a feeding pipe, a pre-chamber ink tank just prior to a head, a piping fitted with a filter, and a piezo head. Temperature was raised to 50° C., while the section from the pre-chamber tank to the head portion was insulated. The piezo head was driven so that it was possible to discharge multi-size dots of 2-20 pl at a resolution of 720×720 dpi, whereby each ink was continuously discharged. Ink droplets were cured 0.1 second after deposition when the deposited ink was exposed to actinic radiation emitted from lamp units on both sides of the carriage. After recording, the ink layer thickness was determined, resulting in the range of 2.3-13 μm. As used in the present invention, “dpi” represents the number of dots per inch or 2.54 cm. Each of the ink-jet images was formed at 25° C. and 30% relative humidity based on the above method.

(Image Forming Method B)

Each image was prepared in the same manner as in Image Forming Method A, except that an ink-jet recording apparatus using the line head recording method, shown in FIG. 2, was employed and each of Inks was loaded.

Exposure and the exposure radiation source employed in the above image forming methods were as follows. Radiation source employed in Image Forming Method A: high pressure mercury lamp V Zero 085 (at a peak wavelength of 254 nm and a maximum illuminance of 400 mW/cm², produced by INTEGRATION TECHNOLOGY Co.)

Radiation source employed in Image Forming Method B: low pressure mercury lamp (a customized lamp of Iwasaki Electric Co., Ltd. in which 5 lamps were arranged as a line radiation source at a exposure area of 120 mm (in the longitudinal direction)×620 mm (in the lateral direction), a peal wavelength of 254 nm and a maximum illuminance of 50 mW/cm²)

Represented illuminance of each of the above radiation sources was determined in terms of integrated illuminance at 254 nm, employing UVPF-A1, produced by Iwasaki Electric Co., Ltd.

<<Evaluation of Formed Images and Inks>>

(Evaluation of Curability)

The surface of each of the formed images was touched by fingers immediately after exposure to actinic radiation, and the resulting curability was evaluated based on the following criteria. Table 2 shows the results. In Table 2, evaluation results of the images by Image Forming Method A was designated as Curability Evaluation A, while evaluation results of the images by Image Forming Method B was designated as Curability Evaluation B.
A: the surface of the formed image was almost no sticky and was sufficiently cured
B: the surface of the formed image resulted in slightly sticky and was sufficiently cured
C: the surface of the formed image was sticky but was almost cured
D: the formed image was not cured and remained fluid
   (Evaluation of Ink Storage Stability)

Each of the inks, prepared as above, was placed in a glass bottle. After tight sealing, the bottle was allowed to stand in an ambience of 60° C. for three days. Thereafter, the precipitation state of pigment particles was visually observed and ink storage stability was evaluated based on the following criteria.
A: Almost no precipitation of pigment particles was noted.
B: In the stationary state, no precipitation of pigments particles was noted, but when the ink bottle was shaken, aggregated pigment particles were noted on the wall of the glass bottle.
D: Aggregated pigment particles were clearly noted on the bottom of the glass bottle.

Table 2 shows the results.

TABLE 2

| | Individual Evaluation Result | | | |
|---|---|---|---|---|
| Ink | Ink Storage | Curability | Curability | |
| No. | Stability | Evaluation A | Evaluation B | Remarks |
| 1 | A | A | A | Present |
| | | | | Invention |
| 2 | A | A | A | Present |
| | | | | Invention |
| 3 | A | A | A | Present |
| | | | | Invention |
| 4 | A | A | A | Present |
| | | | | Invention |
| 5 | A | A | A | Present |
| | | | | Invention |
| 6 | A | A | A | Present |
| | | | | Invention |
| 7 | A | A | A | Present |
| | | | | Invention |
| 8 | A | A | A | Present |
| | | | | Invention |
| 9 | A | A | A | Present |
| | | | | Invention |
| 10 | A | A | A | Present |
| | | | | Invention |
| 11 | A | B | B | Present |
| | | | | Invention |
| 12 | D | A | A | Comparative |
| | | | | Example |
| 13 | D | A | A | Comparative |
| | | | | Example |
| 14 | D | A | A | Comparative |
| | | | | Example |
| 15 | D | A | A | Comparative |
| | | | | Example |
| 16 | B | D | D | Comparative |
| | | | | Example |
| 17 | B | D | D | Comparative |
| | | | | Example |

As can clearly be seen from the results of Table 2, actinic radiation curable ink-jet inks of the present invention, which incorporated benzimidazolone based pigments, dispersing agents, oxetane compounds as a cationically polymerizable monomer, and photolytically acid generating agents, as well as benzimidazolone derivatives, exhibited excellent curability, compared to the comparative examples, even when employing a carriage system ink-jet recording apparatus or a line head system ink-jet recording apparatus. Further, when the inks of the present invention were stored at relatively high temperature for a long period, aggregation of pigment particles was minimal to result in excellent storage stability, compared to comparative examples.

1. An actinic radiation curable ink-jet ink comprising a benzimidazolone based pigment, a dispersing agent, a cationically polymerizable monomer which is an oxetane compound, a photolytically acid generating agent, and a benzimidazolone derivative.

2. The actinic radiation curable ink-jet ink described in claim 1 further comprising a cationically polymerizable monomer which is a compound having an oxirane ring.

3. The actinic radiation curable ink-jet ink described in claim 2,
wherein the compound having an oxirane ring is represented by Formula (1): 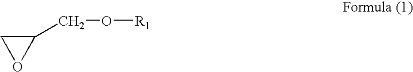
wherein R₁ is an unsubstituted or substituted alkyl group which have 1-10 carbon atoms, an unsubstituted or substituted aromatic group, or an unsubstituted or substituted acyl group.

4. The actinic radiation curable ink-jet ink described in claim 2,
wherein the compound having an oxirane ring is represented by Formula (2): 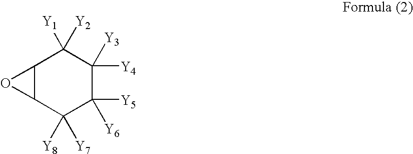
wherein Y₁-Y₈ are each a hydrogen atom, an unsubstituted or substituted alkyl, carbonyl, alkoxy, or cycloalkoxy group, each of Y₁-Y₈ may be different, and Y₁ and Y₈ may combine with each other to form a methylene bond or an ether bond.

5. The actinic radiation curable ink-jet ink described in claim 2,
wherein the compound having an oxirane ring is an α-pinene oxide.

6. The actinic radiation curable ink-jet ink described in claim 2,
wherein the compound having an oxirane ring is 1, 2:8,9-diepoxylimonene.

7. The actinic radiation curable ink-jet ink described in claim 2,
wherein the compound having an oxirane ring is an epoxidized vegetable oil having an unsaturated bond.

8. The actinic radiation curable ink-jet ink described in claim 2,
wherein the compound having an oxirane ring is the compound represented by Formula (A): 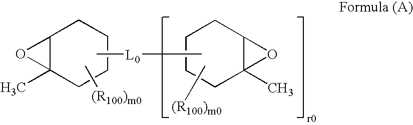
wherein R₁₀₀ is a substituent, m0 is an integer of 0-2, r0 is an integer of 1-3, and L₀ is a (r0+1) valent bonding group having 1-15 carbon atoms, a main chain of which may contain an oxygen atom or a sulfur atom, or L₀ is a single bond.

9. The actinic radiation curable ink-jet ink described in claim 1,
wherein the benzimidazolone derivative is the compound represented by following Formula (B1):
P_{b1}—(SO₃H)ₙ₃ Formula (B1)
wherein P_{b1} is a benzimidazolone pigment residue and n3 is an integer of 1-2.

10. An image forming method comprising the steps of:
(1) ejecting the actinic radiation curable ink-jet ink described in claim 1 from an ink-jet recording head onto a recording material, and
(2) irradiating actinic radiation onto the ejected ink to cure an image on the recording material.

11. The image forming method described in claim 10,
wherein actinic radiation is conducted during 0.001-1 second after deposition of the ink onto the recording material.

12. The image forming method described in claim 10,
wherein a total cured ink layer thickness is 2-25 μm.

13. The image forming method described in claim 10,
wherein a droplet volume of the actinic radiation curable ink-jet ink ejected from the nozzles is 2-20 pl.

14. The image forming method described in claim 10,
wherein the ink-jet recording head is a line head.

15. An ink-jet recording apparatus employed in the image recording method described in claim 10,
wherein the ink-jet recording apparatus has a mechanism in which the actinic radiation curable ink is ejected after the ink and the ink-jet recording head are heated to 35-100° C.
